(19) United States
(12) Patent Application Publication
(10) Pub. No.: US 2004/0081891 A1
(43) Pub. Date: Apr. 29, 2004

(54) Nonaqueous electrolyte secondary cell

(76) Inventors: Akira Yamaguchi, Fukushima (JP); Hideaki Ojima, Fukushima (JP); Ken Segawa, Fukushima (JP); Yuzuru Fukushima, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/469,142

(22) PCT Filed: Dec. 26, 2002
(86) PCT No.: PCT/JP02/13700

(30) Foreign Application Priority Data
Dec. 27, 2001 (JP) 2001-397676

(51) Int. Cl. H01M 10/40

(52) U.S. Cl. 429/303; 429/307; 429/316

(57) ABSTRACT

The present invention concerns a non-aqueous electrolyte secondary battery includes a cathode (2) capable of being electrochemically doped with and dedoped from lithium; an anode (3)capable of being electrochemically doped with and dedoped from lithium; and an immobilized non-aqueous electrolyte or a gel electrolyte (4) interposed between the cathode (2) and the anode (3) and obtained by mixing a low viscosity compound with or dissolving a low viscosity compound in a polymer compound. At least one kind of unsaturated carbonate or a cyclic ester compound is added to the low viscosity compound, so that storage characteristics and cyclic characteristics are improved.

### TECHNICAL FIELD

The present invention relates to a non-aqueous electrolyte secondary battery having an anode and a cathode capable of being electrochemically doped with and dedoped from lithium and a non-aqueous electrolyte such as a gel electrolyte, and more particularly to a non-aqueous electrolyte secondary battery in which cyclic characteristics are improved.

The present application claims a priority based on Japanese Patent Application No. 2001-397676 filed in Dec. 27, 2001 in Japan and this earlier application is applied to the present application with reference thereto.

### BACKGROUND ART

Portable electronic devices such as video cameras with VTRs, portable telephones, lap top computers, etc. have been hitherto widely employed. In such kinds of electronic devices, compact and light electronic devices have been developed by taking the utility of them into consideration. As the power sources of the portable electronic devices, primary batteries and secondary batteries have been used. Recently, the rate of use of the secondary batteries has been improved as batteries capable of being charged.

In the secondary batteries used for the electronic devices, a study and development for improving energy density has been vigorously advanced. Since lithium-ion secondary batteries of these secondary batteries can obtain energy densities higher than those of lead-acid batteries and nickel-cadmium batteries as aqueous electrolyte secondary batteries, they are high in their utility as the power sources of the portable electronic devices.

In each lithium-ion secondary battery, non-aqueous electrolyte solution is used. To prevent the leakage of liquid, a metallic vessel is employed as an outer package. When the metallic vessel is used for the outer package, for instance, thin sheet type battery having a large area, a thin card type battery having a small area, or a battery having a form with high flexibility and high degree of freedom is hardly manufactured.

As effective solving means for this problem, the manufacture of a battery by using an inorganic or organic completely solid electrolyte or a semi-solid electrolyte composed of polymer gel has been studied. Specifically, what is called a solid electrolyte battery, has been proposed, which utilizes a solid polymer electrolyte having a polymer and an electrolyte, or a gel electrolyte obtained by adding non-aqueous electrolyte solution to a matrix polymer as a plasticizer.

In the solid electrolyte battery, since the electrolyte is solid or gel, the electrolyte is fixed without a fear of leakage of liquid and the thickness of the electrolyte can be fixed. The electrolyte and electrodes used in this battery have a good adhesive property so that the contact between the electrolyte and the electrodes can be maintained. Therefore, since the solid electrolyte battery does not need to seal electrolyte solution by the metallic vessel or apply pressure to a battery element, a film type outer package can be used and the thickness of the battery itself can be more reduced.

In the solid electrolyte battery, the outer package vessel is formed by a moisture-proof laminate film made of a polymer film capable of being heat-sealed and a metallic foil so that the outer package vessel can easily have a closed structure by a hot seal or the like. Since the moisture-proof laminate film has a high strength of a film itself and is excellent in its air-tightness, a vessel formned by using this film can be advantageously formed in a thinner and lighter shape and more inexpensively than a metallic vessel.

In an electronic device such as a note book type personal computer in which the high density of electronic elements is achieved, an operation is performed at high speed, and a CPU (Central Processing Unit) is mounted, a heat generation from an electronic circuit part including the CPU is high. Thus, the rise of temperature in the device gives an adverse effect to the battery. In such an electronic device on which the electronic circuit part high in its heat generation is mounted, a cooling fan is provided near the electronic circuit part that generates heat. The device cannot be adequately cooled only by providing the cooling fan.

The portable electronic device is used and carried together with a user and mounted on a vehicle such as a motor vehicle. The temperature in the motor vehicle becomes extremely high in the summer season at high temperature. Especially, the temperature on a dashboard may sometimes rise near to 100° C. When the electronic device such as the portable telephone, the note book type personal computer, a PDA (portable information terminal), etc. is left for a long period on the dashboard in the motor vehicle whose temperature becomes extremely high as described above, the batteries accommodated in the device are badly affected.

Accordingly, also in the battery used for the electronic device disposed under an environment whose temperature becomes extremely high, a battery that is not affected by an adverse influence due to heat is required. Particularly, a battery whose cyclic characteristics are further improved even when the battery is left under the environment of high temperature is requested.

### DISCLOSURE OF THE INVENTION

It is an object of the present invention to provide a new secondary battery capable of overcoming the above-described problems of a conventional secondary battery.

It is another object of the present invention to provide a non-aqueous electrolyte secondary battery excellent in its storage characteristics and cyclic characteristics.

A non-aqueous electrolyte secondary battery according to the present invention comprises a cathode capable of being electrochemically doped with and dedoped from lithium; an anode capable of being electrochemically doped with and dedoped from lithium; and an immobilized non-aqueous electrolyte or a gel electrolyte interposed between the cathode and the anode and obtained by mixing a low viscosity compound with or dissolving a low viscosity compound in a polymer compound. At least one kind of unsaturated carbonate or a cyclic ester compound is added to the low viscosity compound.

Since the non-aqueous electrolyte secondary battery according to the present invention includes the immobilized non-aqueous electrolyte or the gel electrolyte having the low viscosity compound to which at least one kind of unsaturated carbonate or the cyclic ester compound is added, cyclic characteristics after storage at high temperature are excellent.

In the non-aqueous electrolyte secondary battery according to the present invention, a cathode is formed and used by coating both the surfaces of an elongated current collector with active material layers and an anode is formed and used by coating both the surfaces of an elongated current collector with active material layers. The cathode and the anode are longitudinally coiled many times through a separator to form a spirally coiled electrode body. The spirally coiled electrode body is accommodated in an outer package vessel formed by a moisture-proof laminate film made of a polymer film and a metallic foil.

Still another objects of the present invention and specific advantages obtained by the present invention will become more apparent from the explanation of embodiments described by referring to the drawings.

### BRIEF DESCRIPTION OF THE DRAWINGS

FIG. 1 is a perspective view showing a gel electrolyte battery to which the present invention is applied and showing a state that a battery element is accommodated in an outer package film.

FIG. 2 is a sectional view taken along a line II-II in FIG. 1.

FIG. 3 is a perspective view showing a cathode used in a secondary battery according to the present invention.

FIG. 4 is a perspective view showing an anode used in a secondary battery according to the present invention.

### BEST MODE FOR CARRYING OUT THE INVENTION

Now, embodiments of a non-aqueous electrolyte secondary battery to which the present invention is applied will be described in detail by referring to the drawings.

(First Embodiment)

Initially, a first embodiment of a gel electrolyte battery to which the present invention is applied will be described.

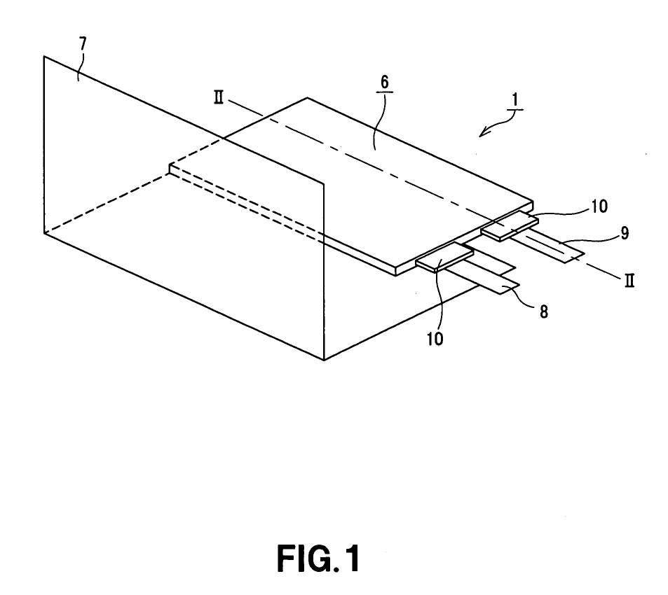

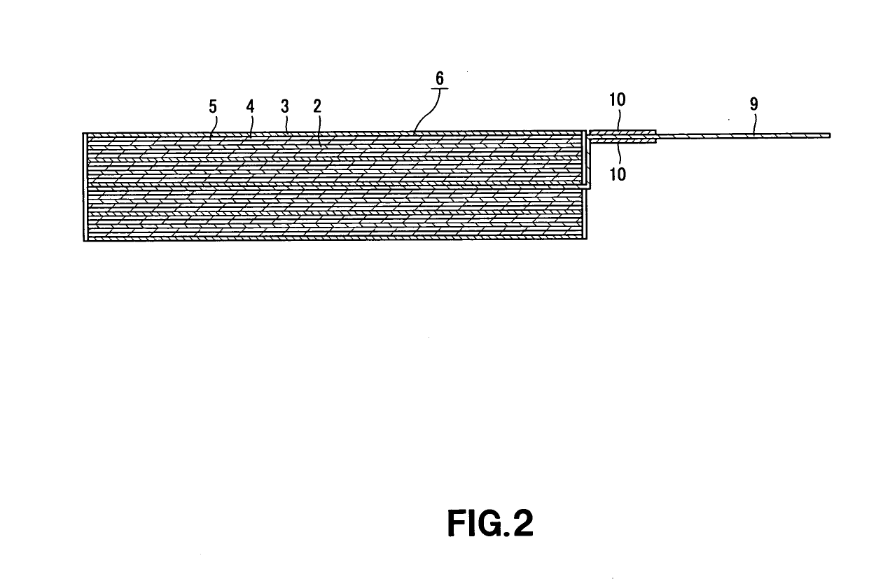

The gel electrolyte battery 1 to which the present invention is applied comprises, as shown in FIGS. 1 and 2, an elongated cathode 2, an elongated anode 3 opposed to the cathode, gel electrolyte layers 4 formed on the cathode 2 and the anode 3, and a separator 5 disposed between the cathode 2 on which the gel electrolyte layer 4 is formed and the anode 3 on which the gel electrolyte layer 4 is formed.

The gel electrolyte battery 1 has a spirally coiled electrode body 6 in which the cathode 2 having the gel electrolyte layer 4 formed thereon and the anode 3 having the gel electrolyte layer 4 formed thereon are laminated through the separator 5, and longitudinally coiled many times. The spirally coiled electrode body 6 is accommodated in an outer package vessel formed by an outer package film 7 made of an insulating material. The outer package vessel in which the spirally coiled electrode body 6 is accommodated is sealed. A cathode lead 8 is connected to the cathode 2 forming the spirally coiled electrode body 6 and an anode lead 9 is connected to the anode 3 forming the spirally coiled electrode body 6. The cathode lead 8 and the anode lead 9 are held by sealing parts as the peripheral edge parts of the outer package vessel formed by using the outer package film 7. Resin films 10 are disposed at parts where the cathode lead 8 and the anode lead 9 come into contact with the outer package film 7.

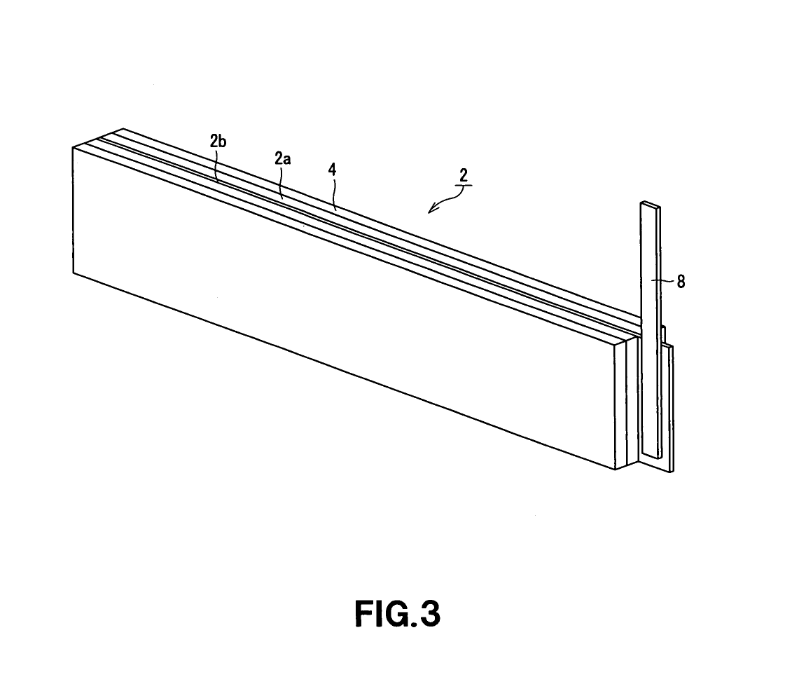

As shown in FIG. 3, in the cathode 2, cathode active material layers 2a including cathode active materials are formed on both the surfaces of a cathode current collector 2b. As the cathode current collector 2b, for instance, a metallic foil such as aluminum foil is used. The cathode active material forming the cathode active material layers 2a with which both the surfaces of the cathode current collector 2b are coated is not especially limited to a specific material, however, an adequate amount of Li is preferably included. For instance, a metal composite oxide composed of lithium and transition metals represented by a general formula LiMₓO_{y} (Here, M indicates at least one kind of Co, Ni, Mn, Fe, Al, V, Ti.) or an intercalation compound including Li are preferable.

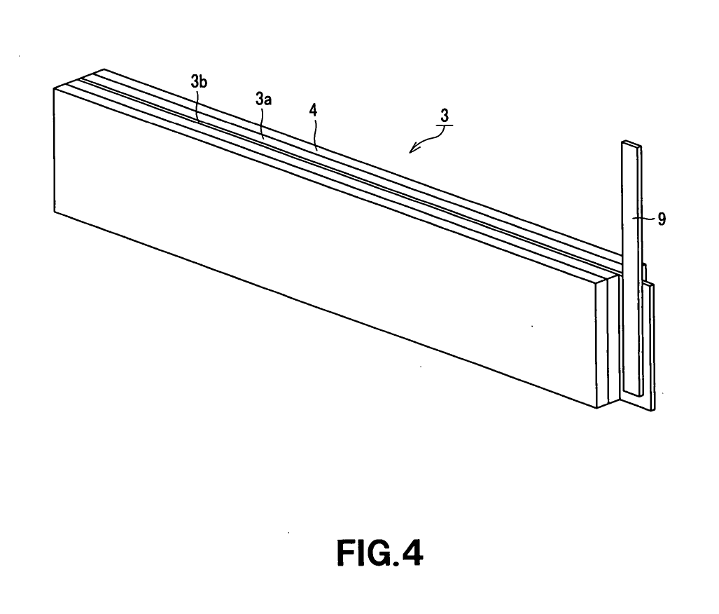

As shown in FIG. 4, in the anode 3, anode active material layers 3a including anode active materials are formed on both the surfaces of an anode current collector 3b. As the anode current collector 3b, for instance, a metallic foil such as a copper foil is used. As the anode active material forming the anode active material layers 3a with which both the surfaces of the anode current collector 3b are coated, any material may be utilized which is electrochemically doped with and dedoped from lithium under a potential of 2.0 V or lower relative to lithium metal. For example, carbonaceous materials, may be used, such as non-graphitizable carbon, artificial graphite, natural graphite, pyrocarbon, coke (pitch coke, needle coke, petroleum coke, etc.), graphite, vitreous carbon, organic polymer compound sintered body (material obtained by sintering and carbonizing phenolic resin, furan resin or the like at suitable temperature), carbon fibers, activated carbon, carbon black, etc. Metals capable of forming alloys with lithium and alloys thereof may be used. Oxides which are doped with or dedoped from lithium under a relatively low potential such as iron oxide, ruthenium oxide, molybdenum oxide, tungsten oxide, titanium oxide, tin oxide, etc., or other nitrides may be likewise employed.

The gel electrolyte layer 4 is formed by allowing non-aqueous electrolyte solution in which electrolyte is dissolved in a non-aqueous solvent to be gelled by a matrix polymer.

Any of electrolyte salts that are used in this kind of battery may be employed. For example, are exemplified LiClO₄, LiAsF₆, LiPF₆, LiBF₄, LiB(CH₆H₅)₄, CH₃SO₃Li, CF₃SO₃Li, LiCl, LiBr, LiN(CF₃SO₂)₂, etc.

Any of non-aqueous solvents that are used in this kind of battery may be also employed. For example, are exemplified, propylene carbonate, ethylene carbonate, γ-butyrolactone, diethyl carbonate, dimethyl carbonate, 1,2-dimethoxyethane, 1,2-diethoxyethane, tetrahydrofuran, 2-methyl tetrahydrofuran, 1,3-dioxolane, 4-methyl-1,3-dioxolane, diethyl ether, sulfolane, methyl sulfolane, acetonitrile, propionitrile, acetic ester, butyric ester, propionic ester, etc.

As the matrix polymer, various kinds of polymers that absorb the non-aqueous electrolyte solution to be gelled can be used. For example, may be used fluorinated polymers such as poly (vinylidene fluoride), poly (vinylidene fluoride-cohexafluoropropylene), etc., ether polymers such as poly (ethylene oxide) or cross-linked materials thereof, poly (acrylonitrile), etc. Especially, fluorinated polymers are preferably used from the viewpoint of oxidation-reduction stability. The matrix polymer includes electrolyte salt so that the matrix polymer has an ionic conductivity.

In the gel electrolyte battery 1 according to the present invention, γ-valerolactone is added to a gel electrolyte. γ-valerolactone is added to the gel electrolyte so that the cyclic characteristics of the gel electrolyte battery 1 can be improved after the battery is stored at high temperature.

The amount of addition of γ-valerolactone is preferably located within a range of 0.5 wt % or higher and 10 wt % or lower of the gel electrolyte. When the amount of addition of γ-valerolactone is lower than 0.5 wt %, an effect for improving the cyclic characteristics of the gel electrolyte battery after the gel electrolyte battery is stored at high temperature cannot be adequately obtained. When the amount of addition of γ-valerolactone is higher than 10 wt %, an initial capacity is lowered. Accordingly, the amount of addition of γ-valerolactone is set to a range of 0.2 wt % or higher and 10 wt % or lower of the gel electrolyte so that the cyclic characteristics after the storage of the gel electrolyte battery at high temperature can be improved without lowering the initial capacity.

In the gel electrolyte battery 1, vinylene carbonate is preferably added to the gel electrolyte together with the γ-valerolactone. The addition of the vinylene carbonate to the gel electrolyte makes it possible to more improve the cyclic characteristic of the gel electrolyte battery 1 after the gel electrolyte battery is stored at high temperature.

The amount of addition of the vinylene carbonate is preferably located within a range of 0.2 wt % or higher and 4 wt % or lower of the gel electrolyte. When the amount of addition of the vinylene carbonate is lower than 0.2 wt %, the cyclic characteristics are deteriorated. When the amount of addition of the vinylene carbonate is higher than 4 wt %, the cyclic characteristics of the gel electrolyte battery after the battery is stored at high temperature are rather deteriorated. Accordingly, the amount of addition of the vinylene carbonate is set to a range of 0.2 wt % or higher and 4 wt % or lower of the gel electrolyte so that the cyclic characteristics, especially, the cyclic characteristics after the storage of the battery at high temperature can be improved.

In the gel electrolyte battery having the above-described structure, since γ-valerolactone is added to the gel electrolyte, or further, vinylene carbonate is added to the gel electrolyte, the cyclic characteristics of the gel electrolyte battery after the storage of the battery at high temperature are especially excellent.

In order to more exhibit the effects realized by the present invention, a compound to be added to the gel electrolyte in the cathode side may be effectively different from a compound to be added to the gel electrolyte in the anode side. Specifically, γ-butyrolactone may be added to the gel electrolyte in the cathode side and vinylene carbonate and γ-valerolactone may be added to the gel electrolyte in the anode side. Further, γ-valerolactone may be added to the gel electrolyte in the cathode side and vinylene carbonate may be added to the gel electrolyte in the anode side.

In manufacturing such a gel electrolyte battery 1, methods for manufacturing the anode and the cathode are not especially limited to specific methods. A method for applying on a current collector a composite mixture obtained by adding a well-known binding agent or the like to a material and adding a solvent thereto, a method for adding a well-known binding agent or the like to a material, heating the obtained mixture and applying the mixture to a current collector, and a method for molding independently a material, or the mixture of the material with an electrically conductive material and further a binding agent to form a compact electrode may be employed, however, the present invention is not limited thereto. More specifically, a slurry composite mixture is prepared by mixing the binding agent, an organic solvent or the like with the material and the composite mixture is applied and dried on the current collector to form the anode or the cathode. Otherwise, whether or not the binding agent is present, while heat is applied to an active material, the material is molded under pressure to form an electrode having strength.

In the above-described embodiment, although an example that the gel electrolyte is used as the non-aqueous electrolyte is described, the present invention is not limited thereto. Both a solid electrolyte including electrolyte salt and a non-aqueous electrolyte solution in which electrolyte salt is dissolved in a non-aqueous solvent can be used. In the solid electrolyte or the gel electrolyte, electrolytes having different components can be employed respectively for the cathode and the anode. When one kind of electrolyte is employed, a non-aqueous electrolyte solution in which the electrolyte is prepared in a non-aqueous solvent can be likewise used.

As the solid electrolyte, both an inorganic solid electrolyte and a solid polymer electrolyte that have lithium ion conductivity can be employed. As the inorganic solid electrolyte, lithium nitride and lithium iodide are exemplified. The solid polymer electrolyte comprises electrolyte salt and a polymer compound for dissolving it. As the polymer compound, ether polymer such as poly (ethylene oxide) or the cross-linked material thereof, poly (inethacrylate) ester, acrylate, etc., can be independently used, or copolymerized or mixed with molecules and the mixture can be used.

In the above-described embodiment, although an example that the elongated cathode and the elongated anode are laminated through the separator and they are further longitudinally coiled to form the spirally coiled electrode body is described, the present invention is not limited thereto. The present invention may be also applied to a case that a rectangular cathode and a rectangular anode are laminated to form an laminated electrode body or a case that the laminated electrode body is alternately folded to form an electrode body.

The form of the above-mentioned gel electrolyte battery 1 according to the present invention is not especially limited to specific forms such as a cylindrical type, a prismatic type, a coin type, a button type, a laminate seal type, etc. The thickness and size of the gel electrolyte battery 1 can be suitably changed.

(Second Embodiment)

Now, a second embodiment of the present invention will be described below. In a gel electrolyte battery of this embodiment, a spirally coiled electrode body comprising an elongated cathode, an elongated anode opposed to the cathode, gel electrolyte layers formed on the cathode and the anode, and a separator disposed between the cathode on which the gel electrolyte layer is formed and the anode on which the gel electrolyte layer is formed is accommodated in a sealed outer package vessel formed of an outer package film made of an insulating material like the above-described gel electrolyte battery 1. The structures of the gel electrolyte battery including the cathode and the anode are substantially the same as those of the cathode 2 and the anode 3, or the like of the above-described gel electrolyte battery 1. Therefore, a further detailed description will be omitted.

In the gel electrolyte battery according to this embodiment, the gel electrolyte layer is formed by allowing non-aqueous electrolyte solution in which an electrolyte is dissolved in a non-aqueous solvent to be gelled by a matrix polymer like the above-described gel electrolyte layer 4. In this gel electrolyte battery, alkyl lactone fluoride represented by a general formula (1) described below is added to the gel electrolyte layer. The addition of alkyl lactone fluoride to a gel electrolyte makes it possible to improve the cyclic characteristics of the gel electrolyte battery after the gel electrolyte battery is stored at high temperature.

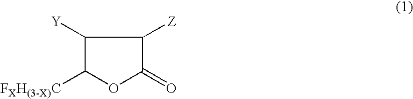

(X=1 to 3)

(X and Y indicate functional groups selected from hydrogen, halogen, alkyl groups, acetyl groups)

Here, the amount of addition of alkyl lactone fluoride is preferably located within a range of 0.5 wt % or higher and 50 wt % or lower of the gel electrolyte. When the amount of addition of alkyl lactone fluoride is lower than 0.5 wt %, an effect for improving the cyclic characteristics of the gel electrolyte battery after the gel electrolyte battery is stored at high temperature cannot be adequately obtained. When the amount of addition of alkyl lactone fluoride is higher than 50 wt %, an initial capacity is lowered. Accordingly, the amount of addition of alkyl lactone fluoride is set to a range of 0.5 wt % or higher and 50 wt % or lower of the gel electrolyte so that the cyclic characteristics after the storage of the gel electrolyte battery at high temperature can be improved without lowering the initial capacity.

As described above, in the gel electrolyte battery according to the present invention, since alkyl lactone fluoride is added to the gel electrolyte, the cyclic characteristics of the gel electrolyte battery after the storage of the gel electrolyte battery at high temperature are especially excellent.

The gel electrolyte battery of this embodiment can be also properly changed without departing the gist of the present invention like the above-described gel electrolyte battery 1.

(Third Embodiment)

Now, a second embodiment of the present invention will be described below. In a gel electrolyte battery of this embodiment, a spirally coiled electrode body comprising an elongated cathode, an elongated anode opposed to the cathode, gel electrolyte layers formed on the cathode and the anode, and a separator disposed between the cathode on which the gel electrolyte layer is formed and the anode on which the gel electrolyte layer is formed is accommodated in a sealed outer package vessel formed of an outer package film made of an insulating material like the above-described gel electrolyte battery 1. The structures of the gel electrolyte battery including the cathode and the anode are substantially the same as those of the cathode 2 and the anode 3, or the like of the above-described gel electrolyte battery 1 in the first embodiment. Therefore, a further detailed description will be omitted.

In the gel electrolyte battery according to this embodiment, the gel electrolyte layer is formed by allowing non-aqueous electrolyte solution in which an electrolyte is dissolved in a non-aqueous solvent to be gelled by a matrix polymer like the above-described gel electrolyte layer 4. In this gel electrolyte battery, β-propyl lactone is added to the gel electrolyte layer. The addition of β-propyl lactone to a gel electrolyte makes it possible to improve the low temperature cyclic characteristics of the gel electrolyte battery.

Here, the amount of addition of β-propyl lactone is preferably located within a range of 0.5 wt % or higher and 10 wt % or lower of the gel electrolyte. When the amount of addition of β-propyl lactone is lower than 0.5 wt %, an initial charging and discharging efficiency is lowered. When the amount of addition of β-propyl lactone is higher than 10 wt %, the low temperature cyclic characteristics are lowered. Accordingly, the amount of addition of β-propyl lactone is set to a range of 0.5 wt % or higher and 10 wt % or lower of the gel electrolyte so that the low temperature cyclic characteristics can be improved without lowering the initial charging and discharging efficiency.

As described above, in the gel electrolyte battery according to this embodiment, since β-propyl lactone is added to the gel electrolyte, the low temperature cyclic characteristics are especially excellent.

The gel electrolyte battery of this embodiment can be also properly changed without departing the gist of the present invention like the above-described gel electrolyte battery 1.

### EXAMPLES

Now, some experimental examples formed to recognize the effects of the present invention will be described below. In below-described examples, although the names of specific compounds and numeric values are exemplified, it is to be understood that the present invention is not limited thereto.

[Experiment 1]

In this Experiment, an effect when γ-valerolactone is added to a gel electrolyte and further vinylene carbonate is added to the gel electrolyte was examined.

(Sample 1)

An anode used in a battery of a Sample 1 was formed as described below.

Initially, coal tar type pitch of 30 parts by weight as a binder was added to coal type coke of 100 parts by weight as a filler and they were mixed together at about 100° C. The mixture was compression-molded by a press to obtain a precursor of a carbon compact. A pitch impregnation/sintering processes that a carbon material compact obtained by heat-treating the precursor at 1000° C. or lower was further impregnated with binder pitch molten at 200° C. or lower and the obtained carbon compact was heat-treated at 1000° C. or lower were repeated several times. Then, the carbon compact was heat-treated under an inert atmosphere at 2800° C. to obtain a graphitizing compact. Then, the graphitizing compact was pulverized and classified to form sample powder.

As a result of performing an X-ray diffraction measurement of the graphite material obtained at this time, the interplanar spacing of a (002) plane was 0.337 nm and the thickness of a C-axis crystallite of the (002) plane was 50.0 nm. True density by a pycnometer method was 2.23. Specific surface by a BET method was 1.6 m²/g. In a particle size distribution by a laser diffraction method, an average particle diameter was 33.0 μm, a 10% cumulative particle size was 13.3 μm, a 50% cumulative particle size was 30.6 μm, a 90% cumulative particle size was 55.7 μm, the average value of the breaking strength of a graphite particle was 7.1 kgf/mm² and bulk density was 0.98 g/cm³.

Subsequently, the mixed sample powder of 90 parts by weight was mixed with polyvinylidene fluoride (PVdF) of 10 parts by weight as a binding agent to prepare an anode composite mixture. The anode composite mixture was dispersed in N-methyl pyrrolidone as a solvent to have slurry (paste).

As an anode current collector, an elongated copper foil having the thickness of 10 μm was used. The anode composite mixture slurry was applied and dried on both the surfaces of the current collector, and then, compression-molded under prescribed pressure to cut the obtained current collector to the size of 800 mm×120 mm and form an elongated anode.

An anode lead was formed by cutting a metal net formed by knitting a copper wire or a nickel wire having the diameter of 50 μm at intervals of 75 μm. The anode lead wire is connected to a part of the anode current collector to which the anode composite mixture is not applied by a spot-welding to have a terminal to be connected to an external part.

A cathode was formned as described below.

Initially, a cathode active material was formed. Lithium carbonate of 0.5 mole was mixed with cobalt carbonate of 1 mole. This mixture was sintered in air for 5 hours at the temperature of 880° C. As a result of performing an X-ray diffraction measurement for the obtained material, a peak satisfactorily corresponded to the peak of LiCoO₂ registered in a JCPDS file.

This LiCoO₂, was pulverized to have powder having the average particle diameter of 8 μm. The LiCoO₂ powder of 95 parts by weight was mixed with lithium carbonate powder of 5 parts by weight. This mixture of 91 parts by weight was mixed with flake graphite of 6 parts by weight as a conductive agent and polyvinylidene fluoride of 3 parts by weight as a binding agent to prepare a cathode composite mixture. The cathode composite mixture was dispersed in N-methyl pyrrolidone to have slurry (paste).

As a cathode current collector, an elongated aluminum foil having the thickness of 20 μm was used. The cathode composite mixture slurry was uniformly applied and dried on both the surfaces of the current collector, and then, compression-molded under prescribed pressure to cut the obtained current collector to the size of 640 mm×118 mm and form an elongated cathode.

A cathode lead was formed by cutting a metal net formed by knitting an aluminum wire having the diameter of 50 μm at intervals of 75 μm. The cathode lead wire is connected to a part of the cathode current collector to which the cathode composite mixture is not applied by a spot-welding to form a terminal to be connected to an external part.

As an electrolyte, a PVdF type gel electrolyte was used. In this electrolyte, a matrix polymer that a polymer (A) in which hexafluoropropylene was copolymerized with vinylidene fluoride at the rate of 7 wt % and its molecular weight was 700000 in terms of weight average molecular weight was mixed with a polymer (B) whose molecular weight was 310000 in the weight ratio A:B=9:1, non-aqueous electrolyte solution, and dimethyl carbonate (DMC) as a solvent of a polymer were mixed together respectively in the weight ratio 1:4:8. The obtained mixture was agitated and dissolved at 70° C. to have a sol and the sol electrode was used.

As non-aqueous solvent, EC (ethylene carbonate):PC (propylene carbonate) VC (vinylene carbonate):GVL (γ-valerolactone) were mixed together in the weight ratio 57.6:38.4:1:3. As electrolyte salt, lithium hexafluorophosphate (LiPF₆) was used to prepare electrolyte solution of 0.8 mol/kg.

Subsequently, the sol electrolyte was applied to the surfaces of the cathode and the anode by using a bar coder. The solvent was evaporated at 70° C. in a constant temperature bath to form a gel electrolyte. The cathode and the anode were laminated and spirally coiled to form a battery element. The battery element was sealed in an accommodating body made of a laminate film under reduced pressure to manufacture a gel electrolyte battery.

(Sample 2)

In a sample 2, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 56.4:37.6:1:5.

(Sample 3)

In a sample 3, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 53.4:35.6:1:10.

(Sample 4)

In a sample 4, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 58.8:39.2:1:1.

(Sample 5)

In a sample 5, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 59.1:39.4:1:0.5.

(Sample 6)

In a sample 6, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 50.4:33.6:1:15.

(Sample 7)

In a sample 7, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 59.3:39.5:1:0.2.

(Sample 8)

In a sample 8, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 58.2:38.8:0:3.

(Sample 9)

In a sample 9, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 59.4:39.6:1:0.

(Sample 10)

In a sample 10, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 60:40:0:0.

(Evaluation)

In the gel electrolyte batteries of the Samples 1 to 10 manufactured as mentioned above, an initial charging and discharging efficiency and cyclic characteristics after the storage of the battery at high temperature were evaluated.

As for the initial charging and discharging efficiency, a constant-current and constant-voltage charging operation was carried out to each battery under conditions of upper limit voltage of 4.2 V and current of 0.2 C. for 10 hours under an atmosphere at 23° C. Then, a constant-current discharging operation of 0.2 C. was carried out in a constant temperature bath at 23° C. up to end voltage of 3.0 V. The initial charging and discharging efficiency was evaluated by obtaining a ratio of an obtained initial discharging capacity to an initial charging capacity in accordance with a following expression.

Initial charging and discharging efficiency (%)=(initial discharging capacity)/(initial charging capacity)×100

When this value is too low, the wastefulness of a charged active material is large.

As for the cyclic characteristics after the storage of the battery at high temperature, a constant-current and constant-voltage charging operation was carried out to each battery under conditions of upper limit voltage of 4.2 V and current of 0.2 C. for 10 hours under an atmosphere at 23° C. Then, a constant-current discharging operation of 0.5 C was carried out in a constant temperature bath at 23° C. up to end voltage of 3.0 V. After that, a constant-current and constant-voltage charging operation was carried out under conditions of upper limit voltage of 4.2 V and current of 0.5 C for 5 hours. Subsequently, the battery was stored for one month in a constant temperature bath at 60° C.

A constant-current discharging operation of 1 C was carried out to each battery in a constant temperature bath at 23° C. up to end voltage of 3.0 V. Then, a constant-current and constant-voltage charging operation was carried out under conditions of upper limit voltage of 4.2 V and current of 1 C for 3 hours. These operations were repeated many times. A deterioration with age of a discharging capacity obtained for each cycle was measured and evaluated by obtaining a ratio of a discharging capacity of a third cycle to a discharging capacity of 250th cycle in accordance with a following expression.

Cyclic characteristics (%)=(discharging capacity of 200th cycle)/(discharging capacity of third cycle)×100.

Here, current 1 C indicates a current value for discharging the rated capacity of the battery for one hour, and 0.2 C and 0.5 C indicate current values for discharging the rated capacity of the battery for 5 hours and 2 hours respectively.

The evaluated results of the cyclic characteristics and the initial charging and discharging efficiencies of the gel electrolyte batteries of the Samples 1 to 10 are shown in Table 1.

TABLE 1

Cathode

| | EC | PC | VC | GVL |
|---|---|---|---|---|
| | (wt %) | (wt %) | (wt %) | (wt %) |
| Sample 1 | 57.6 | 38.4 | 1.0 | 3.0 |
| Sample 2 | 56.4 | 37.6 | 1.0 | 5.0 |
| Sample 3 | 53.4 | 35.6 | 1.0 | 10.0 |
| Sample 4 | 58.8 | 39.2 | 1.0 | 1.0 |
| Sample 5 | 59.1 | 39.4 | 1.0 | 0.5 |
| Sample 6 | 50.4 | 33.6 | 1.0 | 15.0 |
| Sample 7 | 59.3 | 39.5 | 1.0 | 0.2 |
| Sample 8 | 59.4 | 39.6 | 1.0 | 0.0 |
| Sample 9 | 60.0 | 40.0 | 0.0 | 0.0 |
| Sample 10 | 58.2 | 38.8 | 0.0 | 3.0 |

Anode

| | EC | PC | VC | GVL |
|---|---|---|---|---|
| | (wt %) | (wt %) | (wt %) | (wt %) |
| Sample 1 | 57.6 | 38.4 | 1.0 | 3.0 |
| Sample 2 | 56.4 | 37.6 | 1.0 | 5.0 |
| Sample 3 | 53.4 | 35.6 | 1.0 | 10.0 |
| Sample 4 | 58.8 | 39.2 | 1.0 | 1.0 |
| Sample 5 | 59.1 | 39.4 | 1.0 | 0.5 |
| Sample 6 | 50.4 | 33.6 | 1.0 | 15.0 |
| Sample 7 | 59.2 | 39.5 | 1.0 | 0.3 |
| Sample 8 | 59.4 | 39.6 | 1.0 | 0.0 |
| Sample 9 | 60.0 | 40.0 | 0.0 | 0.0 |
| Sample 10 | 58.2 | 38.8 | 0.0 | 3.0 |

| | | Initial Charging and |
|---|---|---|
| | Cyclic Characteristics | Discharging Efficiency |
| | (%) | (%) |
| Sample 1 | 75 | 85 |
| Sample 2 | 71 | 84 |
| Sample 3 | 66 | 82 |
| Sample 4 | 73 | 85 |
| Sample 5 | 70 | 86 |
| Sample 6 | 58 | 75 |
| Sample 7 | 66 | 86 |
| Sample 8 | 62 | 86 |
| Sample 9 | 66 | 79 |
| Sample 10 | 72 | 76 |

As apparent from the results of the Table 1, the Samples 1 to 5 which use both the VC and the GVL as the gel electrolyte are better in their initial charging and discharging efficiency and cyclic characteristics after storage at high temperature than those of the Sample 9 which does not use the VC and the GVL as the gel electrolyte, the Sample 8 which adds the VC to the gel electrolyte and does not use the GVL, and the Sample 10 which uses the GVL and does not add the VC to the gel electrolyte.

In the Sample 8,which adds the GVL to the gel electrolyte and does not adds the VC to the gel electrolyte, the cyclic characteristics after the storage at high temperature are good, however, the initial charging and discharging efficiency is deteriorated. Since the GVL is low in its reduction potential stability, the initial charging and discharging efficiency of the Sample 8 seems to be deteriorated. A reason why the cyclic characteristics after the storage at high temperature are improved seems to reside in that the GVL is decomposed on the cathode to form an oxide film, resulting in the improvement of the cyclic characteristics at high temperature.

A reason why the battery characteristics are improved when the VC is added to the gel electrolyte even if the GVL is employed as in the Samples 1 to 5 seems to reside in that the VC forms a film on the anode upon initial charging operation to improve the stability of the GVL on the anode. In the Sample 6, since the amount of addition of the GVL is too large, the initial charging and discharging efficiency is lowered. In the Sample 7, since the amount of the GVL is small, the cyclic characteristics after the storage at high temperature are not improved. That is, for the amount of addition of the GVL, there exists an optimum ratio. As apparently understood from the Table 1, the amount of addition of the GVL is preferably located within a range of 0.5 wt % or higher and 10 wt % or lower, and more preferably located within a range of 1 wt % or higher and 5 wt % or lower.

Now, Samples 11 to 17 in which the amount of addition of the VC is changed were produced to examine characteristics thereof.

(Sample 11)

In a sample 11, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 57:38:2:3.

(Sample 12)

In a sample 12, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 56.4:37.6:3:3.

(Sample 13)

In a sample 13, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 55.8:37.6:4:3.

(Sample 14)

In a sample 14, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 57.9:38.6:0.5:3.

(Sample 15)

In a sample 15, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 58.1:38.7:0.2:3.

(Sample 16)

In a sample 16, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 54:36:7:3.

(Sample 17)

In a sample 17, a gel electrolyte battery was manufactured in the same manner as the battery of the Sample 1 except that as a non-aqueous solvent of a sol electrolyte, a solvent was used which was obtained by mixing EC:PC:VC:GVL in the weight ratio 58.1:38.8:0.1:3.

TABLE 2

Cathode

| | EC | PC | VC | GVL |
|---|---|---|---|---|
| | (wt %) | (wt %) | (wt %) | (wt %) |
| Sample 11 | 57.0 | 38.0 | 2.0 | 3.0 |
| Sample 12 | 56.4 | 37.6 | 3.0 | 3.0 |
| Sample 13 | 55.8 | 37.2 | 4.0 | 3.0 |
| Sample 14 | 57.9 | 38.6 | 0.5 | 3.0 |
| Sample 15 | 58.1 | 38.7 | 0.2 | 3.0 |
| Sample 16 | 54.0 | 36.0 | 7.0 | 3.0 |
| Sample 17 | 58.1 | 38.8 | 0.1 | 3.0 |

Anode

| | EC | PC | VC | GVL |
|---|---|---|---|---|
| | (wt %) | (wt %) | (wt %) | (wt %) |
| Sample 11 | 57.0 | 38.0 | 2.0 | 3.0 |
| Sample 12 | 56.4 | 37.6 | 3.0 | 3.0 |
| Sample 13 | 55.8 | 37.2 | 4.0 | 3.0 |
| Sample 14 | 57.9 | 38.6 | 0.5 | 3.0 |
| Sample 15 | 58.1 | 38.7 | 0.2 | 3.0 |
| Sample 16 | 54.0 | 36.0 | 7.0 | 3.0 |
| Sample 17 | 58.1 | 38.8 | 0.1 | 3.0 |

| | | Initial Charging and |
|---|---|---|
| | Cyclic Characteristics | Discharging Efficiency |
| | (%) | (%) |
| Sample 11 | 76 | 87 |
| Sample 12 | 71 | 86 |
| Sample 13 | 67 | 84 |
| Sample 14 | 73 | 73 |
| Sample 15 | 70 | 70 |
| Sample 16 | 52 | 70 |
| Sample 17 | 72 | 77 |

As apparent from the Table 2, in the sample 17 in which the amount of addition of vinylene carbonate is small, the cyclic characteristics are deteriorated. In the sample 16 in which the amount of addition of vinylene carbonate is large, the cyclic characteristics after the storage at high temperature are rather deteriorated. On the other hand, in the samples 11 to 15 in which the amount of addition of vinylene carbonate is located within a range of 0.2 wt % or higher and 4 wt % or lower of the gel electrolyte, good cyclic characteristics are obtained. As described above, for the amount of addition of the VC, an optimum ratio is present. Apparently, the amount of addition of the VC is preferably located within a range of 0.2 wt % or higher and 4 wt % or lower, and more preferably located within a range of 0.5 wt %, or higher and 3 wt % or lower.

Now, in Samples 18 to 23 described below, effects obtained when compounds to be added to the gel electrolyte were different between the cathode side and the anode side were examined.

(Sample 18)

In a sample 18, a gel electrolyte battery was manufactured in the same manner as the battery of the Sample 1 except that as a non-aqueous solvent of a sol electrolyte of a cathode side, a solvent was used which was obtained by mixing EC:PC:VC:GVL in the weight ratio 57.6:38.4:1:3, and, as a non-aqueous solvent of a sol electrolyte of an anode side, a solvent was used which was obtained by mixing EC PC:VC:GVL in the weight ratio 59.4:39.6:1:0.

(Sample 19)

In a sample 19, a gel electrolyte battery was manufactured in the same manner as the battery of the Sample 1 except that as a non-aqueous solvent of a sol electrolyte of a cathode side, a solvent was used which was obtained by mixing EC:PC:VC:GVL in the weight ratio 58.2:38.8:0:3, and, as a non-aqueous solvent of a sol electrolyte of an anode side, a solvent was used which was obtained by mixing EC:PC:VC:GVL in the weight ratio 59.4:39.6:1:0.

(Sample 20)

In a sample 20, a gel electrolyte battery was manufactured in the same manner as the battery of the Sample 1 except that as a non-aqueous solvent of a sol electrolyte of a cathode side, a solvent was used which was obtained by mixing EC:PC:VC:GVL in the weight ratio 58.2:38.8:0:3, and, as a non-aqueous solvent of a sol electrolyte of an anode side, a solvent was used which was obtained by mixing EC PC:VC:GVL in the weight ratio 57.6:38.4 1:3.

(Sample 21)

In a sample 21, a gel electrolyte battery was manufactured in the same manner as the battery of the Sample 1 except that as a non-aqueous solvent of a sol electrolyte of a cathode side, a solvent was used which was obtained by mixing EC:PC:VC:GVL in the weight ratio 60:40:0:0, and, as a non-aqueous solvent of a sol electrolyte of an anode side, a solvent was used which was obtained by mixing EC PC:VC:GVL in the weight ratio 57.6:38.4 1:3.

(Sample 22)

In a sample 22, a gel electrolyte battery was manufactured in the same manner as the battery of the Sample 1 except that as a non-aqueous solvent of a sol electrolyte of a cathode side, a solvent was used which was obtained by mixing EC:PC:VC:GVL in the weight ratio 60:40:0:0, and, as a non-aqueous solvent of a sol electrolyte of an anode side, a solvent was used which was obtained by mixing EC:PC:VC:GVL in the weight ratio 58.2:38.8:0:3.

(Sample 23)

In a sample 23, a gel electrolyte battery was manufactured in the same manner as the battery of the Sample 1 except that as a non-aqueous solvent of a sol electrolyte of a cathode side, a solvent was used which was obtained by mixing EC:PC:VC:GVL in the weight ratio 59.4:39.6:1:0, and, as a non-aqueous solvent of a sol electrolyte of an anode side, a solvent was used which was obtained by mixing EC:PC:VC:GVL in the weight ratio 57.6:38.4:1:3.

The evaluated results of the cyclic characteristics and the initial charging and discharging efficiencies obtained likewise for the gel electrolyte batteries of the Samples 18 to 23 are shown in Table 3.

TABLE 3

Cathode

| | EC | PC | VC | GVL |
|---|---|---|---|---|
| | (wt %) | (wt %) | (wt %) | (wt %) |
| Sample 18 | 57.6 | 38.4 | 1.0 | 3.0 |
| Sample 19 | 58.2 | 38.8 | 0.0 | 3.0 |
| Sample 20 | 58.2 | 38.8 | 0.0 | 3.0 |
| Sample 21 | 60.0 | 40.0 | 0.0 | 0.0 |
| Sample 22 | 60.0 | 40.0 | 0.0 | 0.0 |
| Sample 23 | 59.4 | 39.6 | 1.0 | 0.0 |

Anode

| | EC | PC | VC | GVL |
|---|---|---|---|---|
| | (wt %) | (wt %) | (wt %) | (wt %) |
| Sample 18 | 59.4 | 39.6 | 1.0 | 0.0 |
| Sample 19 | 59.4 | 39.6 | 1.0 | 0.0 |
| Sample 20 | 57.6 | 38.4 | 1.0 | 3.0 |
| Sample 21 | 57.6 | 38.4 | 1.0 | 3.0 |
| Sample 22 | 58.2 | 38.8 | 0.0 | 3.0 |
| Sample 23 | 57.6 | 38.4 | 1.0 | 3.0 |

| | | Initial Charging and |
|---|---|---|
| | Cyclic Characteristics | Discharging Efficiency |
| | (%) | (%) |
| Sample 18 | 75 | 86 |
| Sample 19 | 83 | 88 |
| Sample 20 | 80 | 86 |
| Sample 21 | 61 | 86 |
| Sample 22 | 62 | 75 |
| Sample 23 | 61 | 85 |

As apparent from the Table 3, in the samples 18 and 19 in which the GVL was used only for the gel electrolyte of the cathode side, the initial charging and discharging efficiency and the cyclic characteristics after the storage at high temperature were good. In the samples 21 to 23 in which the GVL is used only for the gel electrolyte of the anode side, the cyclic characteristics after the storage at high temperature are not improved. Assuming that the GVL is decomposed on the cathode to form an oxide film so that the cyclic characteristics after the storage at high temperature are improved, the addition of the GVL only to the gel electrolyte of the anode side seems not to improve the cyclic characteristics after the storage at high temperature. In the sample 22 in which the VC is not added to the gel electrolyte of the anode side, the initial charging and discharging efficiency is also deteriorated. On the contrary, in the sample 19 in which the GVL is added to the gel electrolyte of the cathode side and the VC is not added thereto, the cyclic characteristics after the storage at high temperature are especially excellent. This phenomenon seems to arise due to a fact that the VC is apt to generate an oxidative decomposition except an oxide film on the cathode, which is different from the GVL, and accordingly, when the gel electrolyte to which the VC is added is used for the cathode, the cyclic characteristics are slightly deteriorated.

[Experiment 2]

In this Experiment, an effect when alkyl lactone fluoride was added to a gel electrolyte was examined.

(Sample 24)

In a battery of a Sample 24, an anode and a cathode were manufactured in the same manner as those of the above-described Sample 1.

As an electrolyte, a PVdF type gel electrolyte was used. In this electrolyte, a matrix polymer that a polymer (A) in which hexafluoropropylene was copolymerized with vinylidene fluoride at the rate of 7 wt % and its molecular weight was 700000 in terms of weight average molecular weight was mixed with a polymer (B) whose molecular weight was 310000 in the weight ratio A:B=9:1, non-aqueous electrolyte solution, and dimethyl carbonate (DMC) as a solvent of a polymer were mixed together respectively in the weight ratio 1:4:8. The obtained mixture was agitated and dissolved at 70° C. to have a sol and the sol electrolyte was used.

As non-aqueous solvent, a below-described compound 1 was used as alkyl lactone fluoride and EC (ethylene carbonate):PC (propylene carbonate):compound 1 were mixed together in the weight ratio 57:38:5. As electrolyte salt, lithium hexafluorophosphate (LiPF₆) was used to prepare electrolyte solution of 0.8 mol/kg.

Subsequently, the sol electrolyte was applied to the surfaces of the cathode and the anode by using a bar coder. The solvent was evaporated at 70° C. in a constant temperature bath to form a gel electrolyte. The cathode and the anode were laminated and spirally coiled to form a battery element. The battery element was sealed in an accommodating body made of a laminate film under reduced pressure to manufacture a gel electrolyte battery.

(Sample 25)

In a sample 25, a gel electrolyte battery was manufactured in the same manner as the battery of the Sample 24 except that as a non-aqueous solvent of a sol electrolyte, a solvent was used which was obtained by mixing EC:PC:compound 1 in the weight ratio 54:36:10.

(Sample 26)

In a sample 26, a gel electrolyte battery was manufactured in the same manner as the battery of the Sample 24 except that as a non-aqueous solvent of a sol electrolyte, a solvent was used which was obtained by mixing EC:PC:compound 1 in the weight ratio 36:24:40.

(Sample 27)

In a sample 27, a gel electrolyte battery was manufactured in the same manner as the battery of the Sample 24 except that as a non-aqueous solvent of a sol electrolyte, a solvent was used which was obtained by mixing EC:PC:compound 1 in the weight ratio 30:20:50.

(Sample 28)

In a sample 28, a gel electrolyte battery was manufactured in the same manner as the battery of the Sample 24 except that as a non-aqueous solvent of a sol electrolyte, a solvent was used which was obtained by mixing EC:PC:compound 1 in the weight ratio 59.4:39.6:1.

(Sample 29)

In a sample 29, a gel electrolyte battery was manufactured in the same manner as the battery of the Sample 24 except that as a non-aqueous solvent of a sol electrolyte, a solvent was used which was obtained by mixing EC:PC:compound 1 in the weight ratio 59.7:39.8:0.5.

(Sample 30)

In a sample 30, a gel electrolyte battery was manufactured in the same manner as the battery of the Sample 24 except that as a non-aqueous solvent of a sol electrolyte, a solvent was used which was obtained by mixing EC:PC:vinylene carbonate (VC):compound 1 in the weight ratio 56.4:37.6:3:3.

(Sample 31)

In a sample 31, a gel electrolyte battery was manufactured in the same manner as the battery of the Sample 24 except that as a non-aqueous solvent of a sol electrolyte, a solvent was used which was obtained by mixing EC:PC:compound 2 in the weight ratio 57:38:5.

(Sample 32)

In a sample 32, a gel electrolyte battery was manufactured in the same manner as the battery of the Sample 24 except that as a non-aqueous solvent of a sol electrolyte, a solvent was used which was obtained by mixing EC:PC:compound 3 in the weight ratio 57:38:5.

(Sample 33)

In a sample 33, a gel electrolyte battery was manufactured in the same manner as the battery of the Sample 24 except that as a non-aqueous solvent of a sol electrolyte, a solvent was used which was obtained by mixing EC:PC:compound 4 in the weight ratio 57:38:5.

(Sample 34)

In a sample 34, a gel electrolyte battery was manufactured in the same manner as the battery of the Sample 24 except that as a non-aqueous solvent of a sol electrolyte, a solvent was used which was obtained by mixing EC:PC:compound 5 in the weight ratio 57:38:5.

(Sample 35)

In a sample 35, a gel electrolyte battery was manufactured in the same manner as the battery of the Sample 24 except that as a non-aqueous solvent of a sol electrolyte, a solvent was used which was obtained by mixing EC:PC:compound 6 in the weight ratio 57:38:5.

(Sample 36)

In a sample 36, a gel electrolyte battery was manufactured in the same manner as the battery of the Sample 24 except that as a non-aqueous solvent of a sol electrolyte, a solvent was used which was obtained by mixing EC:PC:compound 7 in the weight ratio 57:38:5.

(Sample 37)

In a sample 37, a gel electrolyte battery was manufactured in the same manner as the battery of the Sample 24 except that as a non-aqueous solvent of a sol electrolyte, a solvent was used which was obtained by mixing EC:PC:compound 8 in the weight ratio 57:38:5.

(Sample 38)

In a sample 38, a gel electrolyte battery was manufactured in the same manner as the battery of the Sample 24 except that as a non-aqueous solvent of a sol electrolyte, a solvent was used which was obtained by mixing EC:PC:compound 9 in the weight ratio 57:38:5.

(Sample 39)

In a sample 39, a gel electrolyte battery was manufactured in the same manner as the battery of the Sample 24 except that as a non-aqueous solvent of a sol electrolyte, a solvent was used which was obtained by mixing EC:PC:compound 10 in the weight ratio 57:38:5.

(Sample 40)

In a sample 40, a gel electrolyte battery was manufactured in the same manner as the battery of the Sample 24 except that as a non-aqueous solvent of a sol electrolyte, a solvent was used which was obtained by mixing EC:PC:compound 11 in the weight ratio 57:38:5.

(Sample 41)

In a sample 41, a gel electrolyte battery was manufactured in the same manner as the battery of the Sample 24 except that as a non-aqueous solvent of a sol electrolyte, a solvent was used which was obtained by mixing EC:PC:compound 12 in the weight ratio 57:38:5.

(Sample 42)

In a sample 42, a gel electrolyte battery was manufactured in the same manner as the battery of the Sample 24 except that as a non-aqueous solvent of a sol electrolyte, a solvent was used which was obtained by mixing EC:PC:compound 1 in the weight ratio 51.0:34.0:15.

(Sample 43)

In a sample 43, a gel electrolyte battery was manufactured in the same manner as the battery of the Sample 24 except that as a non-aqueous solvent of a sol electrolyte, a solvent was used which was obtained by mixing EC:PC:compound 1 in the weight ratio 59.9:39.9:0.2.

(Sample 44)

In a sample 44, a gel electrolyte battery was manufactured in the same manner as the battery of the Sample 24 except that as a non-aqueous solvent of a sol electrolyte, a solvent was used which was obtained by mixing EC:PC in the weight ratio 60.0:40.0.

The structural formulas of alkyl lactone fluoride compounds 1 to 12 used in the samples 24 to 44 are shown as follows.

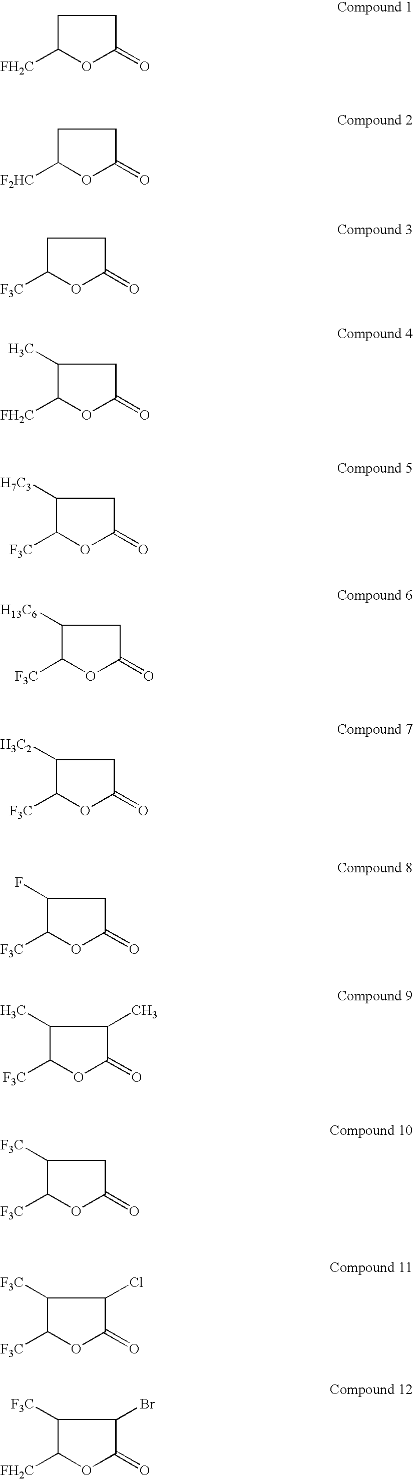

(Evaluation)

In the gel electrolyte battery of each Sample manufactured as mentioned above, the cyclic characteristics were evaluated.

In an evaluation, a constant-current and constant-voltage charging operation was firstly carried out to each battery under conditions of upper limit voltage of 4.2 V and current of 0.2 C for 10 hours in an atmosphere at 23° C. Then, a constant-current discharging operation of 1 C was carried out in a constant temperature bath at 23° C. up to end voltage of 3.0 V. After that, a constant-current and constant-voltage charging operation was carried out under conditions of upper limit voltage of 4.2 V and current of 1 C for 3 hours. These operations were repeated many times. A deterioration with age of a discharging capacity obtained for each cycle was measured. The cyclic characteristics were evaluated by obtaining a ratio of an obtained discharging capacity of a 500th cycle to a discharging capacity of a second cycle in accordance with a following expression.

Cyclic characteristics (%)=(discharging capacity of 500th cycle)/(discharging capacity of third cycle)×100

The evaluated results of the cyclic characteristics of the gel electrolyte batteries of the Samples 24 to 44 are shown in Table 4.

TABLE 4

| | | | | | | Cyclic |
|---|---|---|---|---|---|---|
| | | | | Alkyl Lactone | | Charac- |
| | EC | PC | VC | Fluoride | (wt | teristics |
| | (wt %) | (wt %) | (wt %) | Compound | %) | (%) |
| Sample 24 | 57.0 | 38.0 | | Compound 1 | 5.0 | 76 |
| Sample 25 | 54.0 | 36.0 | | Compound 1 | 10.0 | 78 |
| Sample 26 | 36.0 | 24.0 | | Compound 1 | 40.0 | 70 |
| Sample 27 | 30.0 | 20.0 | | Compound 1 | 50.0 | 66 |
| Sample 28 | 59.4 | 39.6 | | Compound 1 | 1.0 | 74 |
| Sample 29 | 59.7 | 39.8 | | Compound 1 | 0.5 | 70 |
| Sample 30 | 55.2 | 36.8 | 3.0 | Compound 1 | 5.0 | 79 |
| Sample 31 | 57.0 | 38.0 | | Compound 2 | 5.0 | 78 |
| Sample 32 | 57.0 | 38.0 | | Compound 3 | 5.0 | 80 |
| Sample 33 | 57.0 | 38.0 | | Compound 4 | 5.0 | 79 |
| Sample 34 | 57.0 | 38.0 | | Compound 5 | 5.0 | 70 |
| Sample 35 | 57.0 | 38.0 | | Compound 6 | 5.0 | 69 |
| Sample 36 | 57.0 | 38.0 | | Compound 7 | 5.0 | 79 |
| Sample 37 | 57.0 | 38.0 | | Compound 8 | 5.0 | 85 |
| Sample 38 | 57.0 | 38.0 | | Compound 9 | 5.0 | 80 |
| Sample 39 | 57.0 | 38.0 | | Compound 10 | 5.0 | 83 |
| Sample 40 | 57.0 | 38.0 | | Compound 11 | 5.0 | 78 |
| Sample 41 | 57.0 | 38.0 | | Compound 12 | 5.0 | 80 |
| Sample 42 | 24.0 | 16.0 | | Compound 1 | 60.0 | 60 |
| Sample 43 | 59.9 | 39.9 | | Compound 1 | 0.2 | 62 |
| Sample 44 | 60.0 | 40.0 | | — | 0.0 | 60 |

As apparent from the Table 4, in the samples 24 to 30 in which the compound 1 is used as the gel electrolyte, the cyclic characteristics are better than those of the sample 44 in which the compound 1 is not used as the gel electrolyte. This phenomenon seems to arise due to a fact that the cyclic characteristics can be improved by using alkyl lactone fluoride high in its oxidation potential. However, in the sample 42 in which the amount of the compound 1 is too large or in the sample 43 in which the amount of the compound 1 is small, the cyclic characteristics are not improved. That is, the amount of addition of alkyl lactone fluoride has apparently an optimum ratio and is preferably located within a range of 0.5 wt % or higher and 50 wt % or lower, and more preferably, within a range of 1 wt % or higher and 40 wt % or lower. In the samples 31 to 41 in which other alkyl lactone fluoride compounds 2 to 12 are used, the cyclic characteristics were also apparently found to be improved.

[Experiment 3]

In this Experiment, an effect when β-propyl lactone was added to a gel electrolyte was examined.

(Sample 45)

In a battery of a Sample 45, an anode and a cathode were manufactured in the same manner as those of the above-described Sample 1.

As an electrolyte, a PVdF type gel electrolyte was used. In this electrolyte, a matrix polymer that a polymer (A) in which hexafluoropropylene was copolymerized with vinylidene fluoride at the rate of 7 wt % and its molecular weight was 700000 in terms of weight average molecular weight was mixed with a polymer (B) whose molecular weight was 310000 in the weight ratio A:B=9:1, non-aqueous electrolyte solution, and dimethyl carbonate (DMC) as a solvent of a polymer were mixed together respectively in the weight ratio 1:4:8. The obtained mixture was agitated and dissolved at 70° C. to have a sol electrolyte and the sol electrolyte was employed.

As a non-aqueous solvent, EC (ethylene carbonate):PC (propylene carbonate) β-propyl lactone were mixed together in the weight ratio 59.4:39.6:1. As electrolyte salt, lithium hexafluorophosphate (LiPF₆) was used to prepare electrolyte solution of 0.8 mol/kg.

Subsequently, the sol electrolyte was applied to the surfaces of the cathode and the anode by using a bar coder. The solvent was evaporated at 70° C. in a constant temperature bath to form a gel electrolyte. The cathode and the anode were laminated and spirally coiled to form a battery element. The battery element was sealed in an accommodating body made of a laminate film under reduced pressure to manufacture a gel electrolyte battery.

(Sample 46)

In a sample 46, a gel electrolyte battery was manufactured in the same manner as the battery of the Sample 45 except that as a non-aqueous solvent of a sol electrolyte, a solvent was used which was obtained by mixing EC:PC:β-propyl lactone in the weight ratio 58.2:38.8:3.

(Sample 47)

In a sample 47, a gel electrolyte battery was manufactured in the same manner as the battery of the Sample 45 except that as a non-aqueous solvent of a sol electrolyte, a solvent was used which was obtained by mixing EC:PC:β-propyl lactone in the weight ratio 57.0:38.0:5.

(Sample 48)

In a sample 48, a gel electrolyte battery was manufactured in the same manner as the battery of the Sample 45 except that as a non-aqueous solvent of a sol electrolyte, a solvent was used which was obtained by mixing EC:PC:β-propyl lactone in the weight ratio 59.7:39.8:0.5.

(Sample 49)

In a sample 49, a gel electrolyte battery was manufactured in the same manner as the battery of the Sample 45 except that as a non-aqueous solvent of a sol electrolyte, a solvent was used which was obtained by mixing EC:PC:β-propyl lactone in the weight ratio 59.94:39.96:0.1.

(Sample 50)

In a sample 50, a gel electrolyte battery was manufactured in the same manner as the battery of the Sample 45 except that as a non-aqueous solvent of a sol electrolyte, a solvent was used which was obtained by mixing EC:PC:β-propyl lactone in the weight ratio 59.97:39.98:0.05.

(Sample 51)

In a sample 51 a gel electrolyte battery was manufactured in the same manner as the battery of the Sample 45 except that as a non-aqueous solvent of a sol electrolyte, a solvent was used which was obtained by mixing EC:PC:β-propyl lactone in the weight ratio 60.0:40.0:0.1.

(Sample 52)

In a sample 52, a gel electrolyte battery was manufactured in the same manner as the battery of the Sample 45 except that as a non-aqueous solvent of a sol electrolyte, a solvent was used which was obtained by mixing EC:PC:β-propyl lactone in the weight ratio 54.0:36.0:10.0.

(Sample 53)

In a sample 53, a gel electrolyte battery was manufactured in the same manner as the battery of the Sample 45 except that as a non-aqueous solvent of a sol electrolyte, a solvent was used which was obtained by mixing EC:PC:β-propyl lactone in the weight ratio 59.994:39.996:0.01.

(Evaluation)

In the gel electrolyte batteries of the Samples manufactured as mentioned above, an initial charging and discharging efficiency and cyclic characteristics after the storage of the battery at low temperature were evaluated.

As for the initial charging and discharging efficiency, a constant-current and constant-voltage charging operation was firstly carried out to each battery under conditions of upper limit voltage of 4.2 V and current of 0.2 C for 10 hours under an atmosphere at 23° C. Then, a constant-current discharging operation of 0.2 C was carried out in a constant temperature bath at 23° C. up to end voltage of 3.0 V. The initial charging and discharging efficiency was evaluated by obtaining a ratio of an obtained initial discharging capacity to an initial charging capacity in accordance with a following expression.

Initial charging and discharging efficiency (%)=(initial discharging capacity)/(initial charging capacity)×100

As for the cyclic characteristics after the storage of the battery at low temperature, a constant-current and constant-voltage charging operation was firstly carried out to each battery under conditions of upper limit voltage of 4.2 V and current of 0.2 C for 10 hours under an atmosphere at 23° C. Then, a constant-current discharging operation of 0.5 C was carried out in a constant temperature bath at 23° C. up to end voltage of 3.0 V. After that, a constant-current and constant-voltage charging operation was carried out under conditions of upper limit voltage of 4.2 V and current of 0.5 C for 5 hours. Subsequently, the battery was stored for three hours in a constant temperature bath at −20° C. A constant-current discharging operation of 0.5 C was carried out to each battery in a constant temperature bath at −20° C. up to end voltage of 3.0 V. A discharging capacity obtained at the temperature of −20° C. was measured and the cyclic characteristics at low temperature was evaluated by obtaining a ratio of a discharging capacity of a third cycle to a discharging capacity of a 250th cycle in accordance with a following expression.

Low temperature characteristics (%)=(discharging capacity at −20° C.)/(discharging capacity at 23° C.)×100.

The evaluated results of the cyclic characteristics and the initial charging and discharging efficiencies of the gel electrolyte batteries of the Samples 45 to 53 are shown in Table 5.

TABLE 5

| | EC | PC | β-propyl lactone |
|---|---|---|---|
| | (wt %) | (wt %) | (wt %) |
| Sample 45 | 59.4 | 39.6 | 1.0 |
| Sample 46 | 58.2 | 38.8 | 3.0 |
| Sample 47 | 57.0 | 38.0 | 5.0 |
| Sample 48 | 59.7 | 39.8 | 0.5 |
| Sample 49 | 59.94 | 39.96 | 0.1 |
| Sample 50 | 59.97 | 39.98 | 0.05 |
| Sample 51 | 60.0 | 40.0 | 0.0 |
| Sample 52 | 54.0 | 36.0 | 10.0 |
| Sample 53 | 59.994 | 39.996 | 0.01 |

| | Initial Charging and | Low Temperature |
|---|---|---|
| | Discharging Efficiency | Characteristics at |
| | (%) | −20° C. (%) |
| Sample 45 | 90 | 32 |
| Sample 46 | 89 | 31 |
| Sample 47 | 88 | 29 |
| Sample 48 | 88 | 31 |
| Sample 49 | 85 | 30 |
| Sample 50 | 83 | 31 |
| Sample 51 | 79 | 30 |
| Sample 52 | 86 | 20 |
| Sample 53 | 80 | 30 |

As apparent from the Table 5, in the samples 45 to 50 in which β-propyl lactone is used as the gel electrolyte, the initial charging and discharging efficiencies are better than that of the sample 51 in which β-propyl lactone is not used as the gel electrolyte. This phenomenon seems to arise due to a reason that β-propyl lactone is decomposed on the anode upon initial charging operation to form a film due to this decomposition so that the decomposition of EC or PC on the anode is suppressed and the initial charging and discharging efficiency is improved. In the sample 52 in which the amount of β-propyl lactone is too large, the low temperature characteristics are deteriorated. This phenomenon seems to arise due to a reason that the thickness of the film on the anode is excessively increased to raise the resistance of the anode. In the wt % or higher and 3 wt % or lower.

The present invention is not limited to the above embodiment described by referring to the drawings and it is apparent for a person with ordinary skill in the art that various changes, substitutions and equivalence thereto may be made without departing the attached claims and the gist thereof.

Industrial Applicability

According to the present invention, a non-aqueous electrolyte secondary battery includes a cathode capable of being electrochemically doped with and dedoped from lithium; an anode capable of being electrochemically doped with and dedoped from lithium; and an immobilized non-aqueous electrolyte or a gel electrolyte interposed between the cathode and the anode and obtained by mixing a low viscosity compound with or dissolving a low viscosity compound in a polymer compound. At least one kind of unsaturated carbonate or a cyclic ester compound is added to the low viscosity compound. Accordingly, the non-aqueous electrolyte secondary battery excellent in its cyclic characteristics after storage at high temperature can be realized.

1. A non-aqueous electrolyte secondary battery comprising:
a cathode capable of being electrochemically doped with and dedoped from lithium;
an anode capable of being electrochemically doped with and dedoped from lithium; and
an immobilized non-aqueous electrolyte or a gel electrolyte interposed between the cathode and the anode and obtained by mixing a low viscosity compound with or dissolving a low viscosity compound in a polymer compound, wherein at least one kind of unsaturated carbonate or a cyclic ester compound is added to the low viscosity compound.

2. The non-aqueous electrolyte secondary battery according to claim 1, wherein the cyclic ester compound includes a cyclic lactone compound.

3. The non-aqueous electrolyte secondary battery according to claim 2, wherein at least one kind of vinylene carbonate or γ-valerolactone is further added to the low viscosity compound.

4. The non-aqueous electrolyte secondary battery according to claim 3, wherein the amount of addition of vinylene carbonate is located within a range of 0.2 wt % or higher to 4 wt % or lower of the low viscosity compound.

5. The non-aqueous electrolyte secondary battery according to claim 3, wherein the amount of addition of γ-valerolactone is located within a range of 0.5 wt % or higher and 10 wt % or lower of the low viscosity compound.

6. The non-aqueous electrolyte secondary battery according to claim 3, wherein γ-butyrolactone is added to the gel electrolyte in a cathode side and vinylene carbonate and γ-valerolactone are added to the gel electrolyte in an anode side.

7. The non-aqueous electrolyte secondary battery according to claim 3, wherein γ-valerolactone is added to the gel electrolyte in the cathode side and vinylene carbonate is added to the gel electrolyte in the anode side.

8. The non-aqueous electrolyte secondary battery according to claim 2, wherein alkyl lactone fluoride represented by a below-described general formula (1) is added to the low viscosity compound. 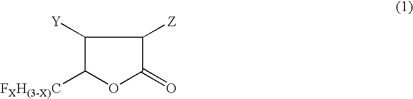
(X=1 to 3)
(X and Y indicate functional groups selected from hydrogen, halogen, alkyl groups and acetyl groups).

9. The non-aqueous electrolyte secondary battery according to claim 8, wherein the amount of addition of alkyl lactone fluoride is located within a range of 0.5 wt % or higher and 50 wt % or lower of the low viscosity compound.

10. The non-aqueous electrolyte secondary battery according to claim 2, wherein β-propyl lactone is further added to the low viscosity compound.

11. The non-aqueous electrolyte secondary battery according to claim 10, wherein the amount of addition of β-propyl lactone is located within a range of 0.05 wt % or higher and 5 wt % or lower of the low viscosity compound.

12. The non-aqueous electrolyte secondary battery according to claim 1 comprising:
the cathode being formed by coating both the surfaces of an elongated current collector with active material layers, the anode being formed by coating both the surfaces of an elongated current collector with active material layers, and a spirally coiled electrode body being formed by longitudinally coiling the cathode and the anode many times through a separator, wherein the spirally coiled electrode body is accommodated in an outer package formed by a moisture-proof laminate film made of a polymer film and a metallic foil.

13. The non-aqueous electrolyte secondary battery according to claim 1, wherein the polymer compound is a fluorine compound.
